(19) United States
(12) Patent Application Publication
(10) Pub. No.: US 2026/0362430 A1
(43) Pub. Date: Nov. 12, 2026

(54) INITIAL ACCESS WITH ON-DEMAND UPLINK MONITORING

(71) Applicant: QUALCOMM Incorporated, San Diego, CA (US)

(72) Inventors: Ahmed BEDEWY, Hillsborough, NJ (US); Jianghong LUO, Skillman, NJ (US); Navid ABEDINI, Basking Ridge, NJ (US); Aria HASANZADEZONUZY, Chatham, NJ (US)

(21) Appl. No.: 19/201,403

(22) Filed: May 7, 2025

(51) Int. Cl. H04W 72/21; H04W 74/0833

(52) U.S. Cl. CPC H04W 72/21; H04W 74/0833

(57) ABSTRACT

Various aspects of the present disclosure generally relate to wireless communication. In some aspects, a user equipment (UE) may receive, from a first network node, a configuration for on-demand uplink monitoring associated with one or more network nodes. In some aspects, the configuration may indicate one or more resources dedicated for requesting on-demand uplink monitoring. The UE may transmit, to the first network node, a first uplink message requesting on-demand uplink monitoring at a second network node of the one or more network nodes in accordance with the configuration. In some aspects, the first uplink message may be transmitted via a resource of the one or more resources for requesting on-demand uplink monitoring. The UE may transmit, to the second network node, a second uplink message in accordance with the configuration. Numerous other aspects are described.

### FIELD OF THE DISCLOSURE

Aspects of the present disclosure generally relate to wireless communication and specifically relate to techniques, apparatuses, and methods associated with initial access with on-demand uplink monitoring.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication systems, some network nodes may be configured to implement network energy savings (NES) techniques, which may be used to reduce deployment or operational costs. In some cases, a network node configured to implement NES techniques may not provide camping service for user equipments. Additionally, or alternatively, the network node may be configured to transmit common information such as synchronization signal blocks periodically or to not transmit the common information.

### SUMMARY

The systems, methods, and devices of this disclosure each have several innovative aspects, no single one of which is solely responsible for the desirable attributes disclosed herein.

Some aspects described herein relate to an apparatus for wireless communication at a user equipment (UE). The apparatus may include one or more memories and one or more processors coupled to the one or more memories and individually or collectively configured to cause the apparatus to receive, from a first network node, a configuration for on-demand uplink monitoring associated with one or more network nodes; transmit, to the first network node, a first uplink message requesting on-demand uplink monitoring at a second network node of the one or more network nodes in accordance with the configuration; and to transmit, to the second network node, a second uplink message in accordance with the configuration.

Some aspects described herein relate to an apparatus for wireless communication at a network node. The apparatus may include one or more memories and one or more processors coupled to the one or more memories and individually or collectively configured to cause the apparatus to transmit, to a UE, a configuration for on-demand uplink monitoring associated with one or more network nodes; receive, from the UE, an uplink message requesting on-demand uplink monitoring at a second network node of the one or more network nodes in accordance with the configuration; and transmit, to the second network node, a message to initiate on-demand uplink monitoring in accordance with the uplink message.

Some aspects described herein relate to a method of wireless communication performed by a UE. The method may include receiving, from a first network node, a configuration for on-demand uplink monitoring associated with one or more network nodes. The method may include transmitting, to the first network node, a first uplink message requesting on-demand uplink monitoring at a second network node of the one or more network nodes in accordance with the configuration. The method may include transmitting, to the second network node, a second uplink message in accordance with the configuration.

Some aspects described herein relate to a method of wireless communication performed by a network node. The method may include transmitting, to a UE, a configuration for on-demand uplink monitoring associated with one or more network nodes. The method may include receiving, from the UE, an uplink message requesting on-demand uplink monitoring at a second network node of the one or more network nodes in accordance with the configuration. The method may include transmitting, to the second network node, a message to initiate on-demand uplink monitoring in accordance with the uplink message.

Some aspects described herein relate to a non-transitory computer-readable medium that stores a set of instructions for wireless communication by a UE. The set of instructions, when executed by one or more processors of the UE, may cause the UE to receive, from a first network node, a configuration for on-demand uplink monitoring associated with one or more network nodes. The set of instructions, when executed by one or more processors of the UE, may cause the UE to transmit, to the first network node, a first uplink message requesting on-demand uplink monitoring at a second network node of the one or more network nodes in accordance with the configuration. The set of instructions, when executed by one or more processors of the UE, may cause the UE to transmit, to the second network node, a second uplink message in accordance with the configuration.

Some aspects described herein relate to a non-transitory computer-readable medium that stores a set of instructions for wireless communication by a network node. The set of instructions, when executed by one or more processors of the network node, may cause the network node to transmit, to a UE, a configuration for on-demand uplink monitoring associated with one or more network nodes. The set of instructions, when executed by one or more processors of the network node, may cause the network node to receive, from the UE, an uplink message requesting on-demand uplink monitoring at a second network node of the one or more network nodes in accordance with the configuration. The set of instructions, when executed by one or more processors of the network node, may cause the network node to transmit, to the second network node, a message to initiate on-demand uplink monitoring in accordance with the uplink message.

Some aspects described herein relate to an apparatus for wireless communication. The apparatus may include means for receiving, from a first network node, a configuration for on-demand uplink monitoring associated with one or more network nodes. The apparatus may include means for transmitting, to the first network node, a first uplink message requesting on-demand uplink monitoring at a second network node of the one or more network nodes in accordance with the configuration. The apparatus may include means for transmitting, to the second network node, a second uplink message in accordance with the configuration.

Some aspects described herein relate to an apparatus for wireless communication. The apparatus may include means for transmitting, to a UE, a configuration for on-demand uplink monitoring associated with one or more network nodes. The apparatus may include means for receiving, from the UE, an uplink message requesting on-demand uplink monitoring at a second network node of the one or more network nodes in accordance with the configuration. The apparatus may include means for transmitting, to the second network node, a message to initiate on-demand uplink monitoring in accordance with the uplink message.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of physical channels and reference signals in a wireless network.

FIG. 3 is a diagram illustrating an example of a two-step random access channel (RACH) procedure and a four-step RACH procedure.

FIG. 4 is a diagram illustrating an example associated with access procedures with on-demand uplink (OD-UL) monitoring.

FIG. 5 is a diagram illustrating an example associated with access procedures with OD-UL monitoring.

FIG. 6 is a diagram illustrating an example process performed, for example, at a user equipment (UE) or an apparatus of a UE.

FIG. 7 is a diagram illustrating an example process performed, for example, at a network node or an apparatus of a network node.

FIG. 8 is a diagram of an example apparatus for wireless communication.

FIG. 9 is a diagram of an example apparatus for wireless communication.

### DETAILED DESCRIPTION

In some wireless communication systems, some network nodes may be configured to implement network energy savings (NES) techniques, which may be used to reduce deployment or operational costs. In some cases, a network node configured to implement NES techniques (e.g., an NES network node or NES cell) may be configured such that the network node does not provide camping service to a user equipment (UE) (e.g., where a UE in an idle or inactive mode may remain connected to the network node, such as to receive paging), and the network node may be configured to directly set up a radio resource control (RRC) connection with the UE. An anchor network node, which may have a larger coverage area than a network node configured for NES techniques, may be configured to provide the camping service to UEs within the coverage of the anchor network node. In some cases, one or more network nodes configured for NES techniques may operate within the coverage area of the anchor network node.

In some cases, to support an access procedure for a UE, a network node configured for NES techniques may periodically transmit a discovery signal, such as a synchronization signal block (SSB). The discovery signal may indicate that the network node is to periodically monitor for uplink (UL) communications, and the discovery signal may indicate one or more periodic UL monitoring windows during which the network node periodically monitors for UL communications. The UE may perform a random access channel (RACH) procedure with the network node during a periodic UL monitoring window indicated by the discovery signal. In these cases, however, the network node is still configured to periodically monitor for UL communications to support RACH procedures for UEs, which may be associated with energy consumption at the network node.

In some other implementations, a first network node configured for NES techniques may periodically transmit the discovery signal (e.g., the SSB), but the first network node is not configured to periodically monitor for UL communications. To initiate communications with the first network node, the UE may initiate a RACH procedure with a second network node (e.g., an anchor network node), and the second network node may transmit a configuration (e.g., an RRC configuration) to the UE for communications with the first network node. In some cases, the second network node may transmit a measurement configuration for the UE to perform measurements for a handover procedure (e.g., Layer 3 measurements, for an RRC handover, or Layer 1 measurements, for a lower-layer triggered mobility handover) for the UE from the second network node to the first network node. While these techniques may reduce energy consumption at the first network node, as the first network node does not perform UL monitoring, latency may be significantly increased relative to techniques where the first network node is configured to periodically monitor for UL communications due to the handover procedure for the UE from the second network node to the first network node.

Various aspects relate generally to initial access techniques with on-demand UL (OD-UL) monitoring. Some aspects relate more specifically to a UE receiving, from a first network node (e.g., an anchor network node or cell), a configuration for OD-UL monitoring associated with one or more other network nodes (e.g., NES network nodes or cells). In some aspects, the configuration may indicate one or more physical RACH (PRACH) resources of the first network node for requesting OD-UL monitoring at the one or more network nodes. For instance, the one or more PRACH resources may include at least a first PRACH resource dedicated for requesting OD-UL monitoring at a second network node of the one or more network nodes. In some aspects, the UE may transmit a message requesting OD-UL monitoring at the second network node via the first PRACH resource. In some aspects, the message may indicate the second network node or a beam for communicating with the second network node. The first network node may receive the message and may transmit one or more messages (e.g., via a backhaul link) to the second network node to activate OD-UL at the second network node. In some aspects, the UE may then perform communications with the second network node in accordance with the activation of the OD-UL. For instance, the UE may transmit a UL message to the second network node in accordance with a RACH-less access procedure.

Particular aspects of the subject matter described in this disclosure can be implemented to realize one or more of the following technical advantages. By the network node being configured to transmit the configuration to the UE, the UE may be able to request OD-UL monitoring for one or multiple network nodes detected by the UE that may be using NES techniques. Additionally, by configuring the first network node to activate OD-UL monitoring at the second network node, the second network node may be configured such that the second network node does not periodically monitor for UL monitoring to support initial access for UEs unless OD-UL monitoring is activated by the first network node, thereby reducing power consumption and overhead associated with the periodic UL monitoring. Furthermore, by the UE being configured to transmit the message via the PRACH resource that may indicate information such as a beam for communications with the second network node, the UE may be configured to perform a RACH-less access procedure when initiating communication with the second network node, thereby reducing latency associated with transmission of the UL message to the second network node associated with performing a RACH procedure.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

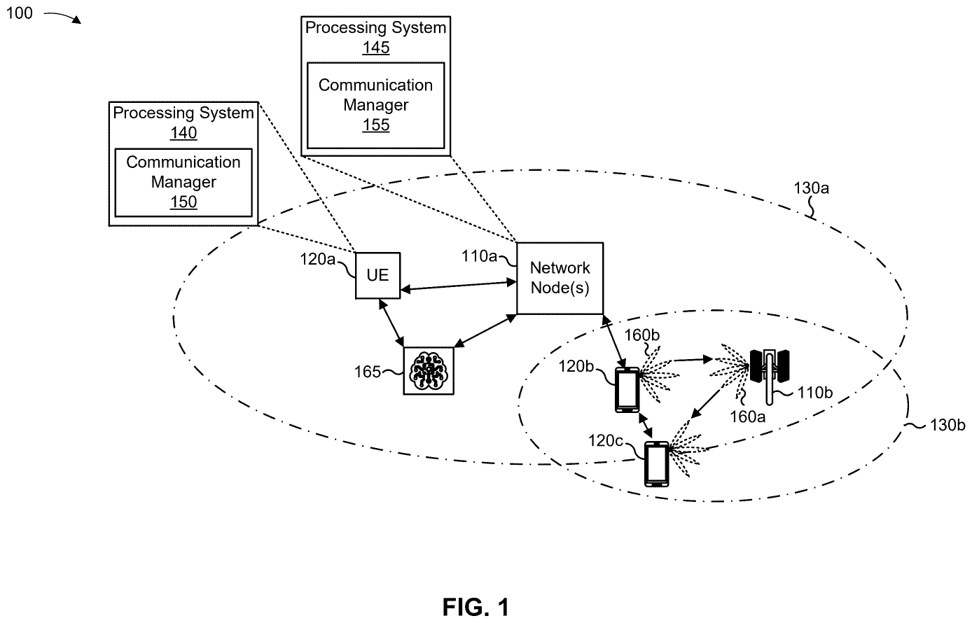

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For instance, in FIG. 1, the network nodes 110 support communication with a UE 120a, a UE 120b, and a UE 120c (each of which also may be referred to herein simply as a “UE 120”). In some cases, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some cases, each of the network nodes 110 and the UEs 120 may communicate using one or multiple component carriers in one or more operating bands or ranges. Typically, various operating bands are defined as frequency range designations FR1 (510 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 400 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For instance, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (e.g., the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other cases, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (e.g., operatively coupled, communicatively coupled, electronically coupled, or electrically coupled) with one or more of the processors. One or more of the memories may individually or collectively store processor-executable code or instructions (such as software) (which may be referred to as “one or more code-storing memories” or “code-storing memory circuitry”). A “code-storing memory” or “code-storing memory circuitry” may refer to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some cases, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some cases, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). A network node 110 may be a device or system that implements a part of a radio protocol stack, a device or system that implements a full radio protocol stack (such as a full gNB protocol stack), or a collection of devices or systems that collectively implement the full radio protocol stack. For instance, and as shown, a network node 110 may be an aggregated network node having an aggregated architecture, meaning that the network node 110 may implement a full radio protocol stack that is physically and logically integrated within a single physical structure in the wireless communication network 100. An aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some cases, a DU also may host a lower PHY layer that is configured to perform functions, such as a fast Fourier transform (FFT), an inverse FFT (IFFT), beamforming, or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an Ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some cases, a network node 110 may be, may include, or may operate as an RU, a TRP, or a base station that communicates with one or more UEs 120 via a radio access link (which may be referred to as a “Uu” link). The radio access link may include a downlink and a UL. “Downlink” (or “DL”) refers to a communication direction from a network node 110 to a UE 120, and UL refers to a communication direction from a UE 120 to a network node 110. Downlink and UL resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both a UL BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or UL grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For instance, a PDCCH can carry DCI, while a PDSCH can carry a MAC control element (MAC-CE), an RRC message, or user data, among other examples. Each PDSCH may carry one or more transport blocks (TBs) of data.

As used herein, a UL signal may include a reference signal, control information, or data. UL reference signals may include a sounding reference signal (SRS), a PTRS, and a DMRS, among other examples. A UL signal carrying control information or data may be transmitted via a UL channel. A UL channel may include one or more control channels for transmitting control information and one or more data channels for transmitting data. UL reference signals may be transmitted in addition to, or multiplexed with, UL control channel communications or UL data channel communications. A UL control channel may be specifically used to transmit UL control information (UCI) from a UE 120 to a network node 110. A UL data channel may be used to transmit UL data (for example, user data associated with a UE 120) from a UE 120 to a network node 110. UL control channels may include physical UL control channels (PUCCHs), and UL data channels may include physical UL shared channels (PUSCHs). Control information or data communications may be transmitted on a PUCCH and PUSCH, respectively. For instance, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), UL power control information (for example, a UL TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some cases, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or a UL signal. For instance, the network node 110 may select an MCS for a downlink signal in accordance with UCI received from the UE 120 or may transmit, to the UE 120, an indication of an MCS to be applied for a UL signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some cases, the network node 110 or the UE 120 (for example, using the processing system 145 or the processing system 140, respectively, or one or more coupled encoders or modems) may perform a channel coding operation or a forward error correction (FEC) operation to control errors in transmitted information. The network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or UL transmission, respectively. In some cases, the network node 110a or the UE 120a may perform codebook-based precoding or non-codebook-based precoding. Codebook-based precoding may involve selecting a precoder (for example, a precoding matrix) using a codebook. The network node 110a may provide precoding information indicating which precoder, defined by the codebook, is to be used by the UE 120a. Non-codebook-based precoding may involve selecting or deriving a precoder based on, or otherwise associated with, one or more downlink or UL signal measurements. The network node 110a or the UE 120a may transmit the processed downlink or UL signals, respectively, via one or more antennas.

The network node 110a or the UE 120a may receive UL signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received UL or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or UL signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or UL signals.

In some cases, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. A network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some cases, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some cases, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. An initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). In some cases, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other cases of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For instance, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some cases, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some cases, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive, from a first network node, a configuration for OD-UL monitoring associated with one or more network nodes; transmit, to the first network node, a first UL message requesting OD-UL monitoring at a second network node of the one or more network nodes in accordance with the configuration; and transmit, to the second network node, a second UL message in accordance with the configuration. Additionally, or alternatively, the communication manager 150 may perform one or more other operations described herein.

In some aspects, the network node 110 may include a communication manager 155. As described in more detail elsewhere herein, the communication manager 155 may transmit, to a UE, a configuration for OD-UL monitoring associated with one or more network nodes; receive, from the UE, a UL message requesting OD-UL monitoring at a second network node of the one or more network nodes in accordance with the configuration; and transmit, to the second network node, a message to initiate OD-UL monitoring in accordance with the UL message. Additionally, or alternatively, the communication manager 155 may perform one or more other operations described herein.

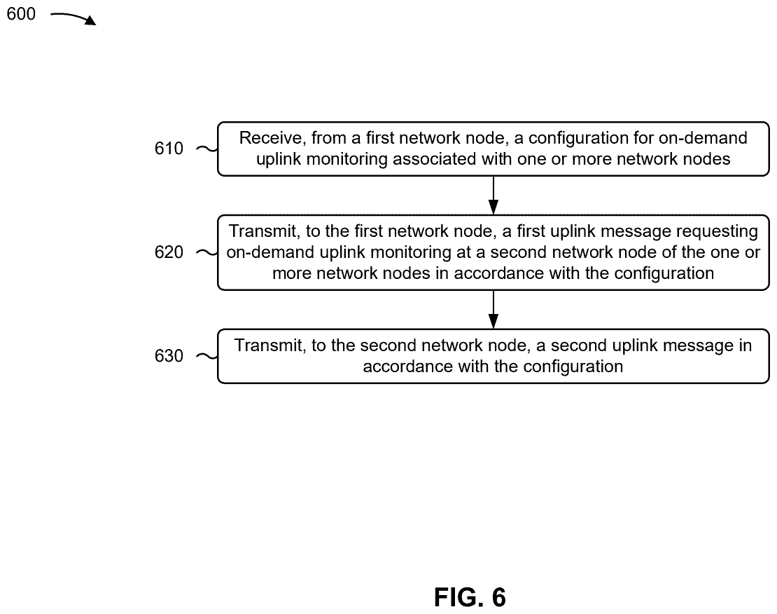

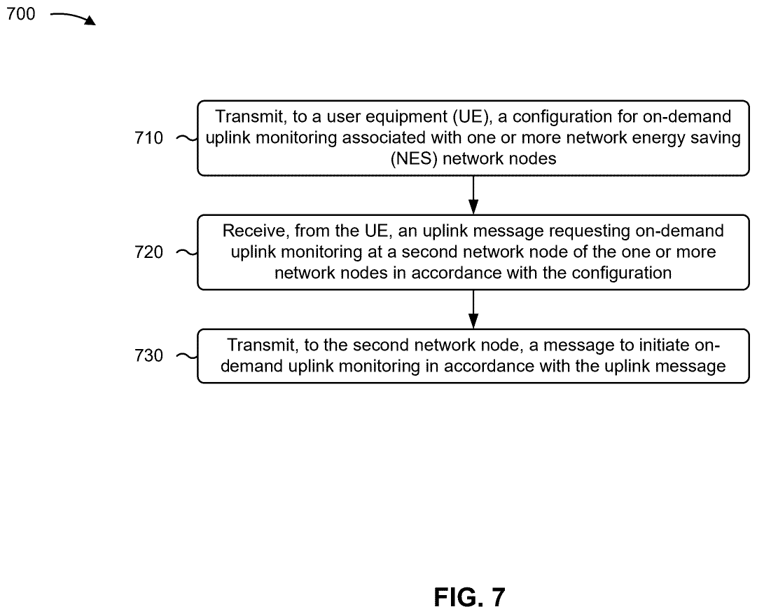

The network node 110, the processing system 145 of the network node 110, the UE 120, the processing system 140 of the UE 120, or any other component(s) of FIG. 1 may implement one or more techniques or perform one or more operations associated with initial access with OD-UL monitoring, as described in more detail elsewhere herein. For instance, the processing system 145 of the network node 110, or the processing system 140 of the UE 120 may perform or direct operations of process 600 of FIG. 6, process 700 of FIG. 7, or other processes as described herein (alone or in conjunction with one or more other processors). Memory of the network node 110 may store data and program code (or instructions) for the network node 110. In some aspects, the memory of the network node 110 may store data relating to a UE 120, such as RRC state information or a UE context. Memory of a UE 120 may store data and program code (or instructions) for the UE 120, such as context information. In some aspects, the memory of the UE 120 or the memory of the network node 110 may include a non-transitory computer-readable medium storing a set of instructions for wireless communication. In some cases, the set of instructions, when executed by one or more processors (for example, of the processing system 145 or the processing system 140) of the network node 110, or the UE 120, may cause the one or more processors to perform process 600 of FIG. 6, process 700 of FIG. 7, or other processes as described herein. In some cases, executing instructions may include running the instructions, converting the instructions, compiling the instructions, or interpreting the instructions, among other examples.

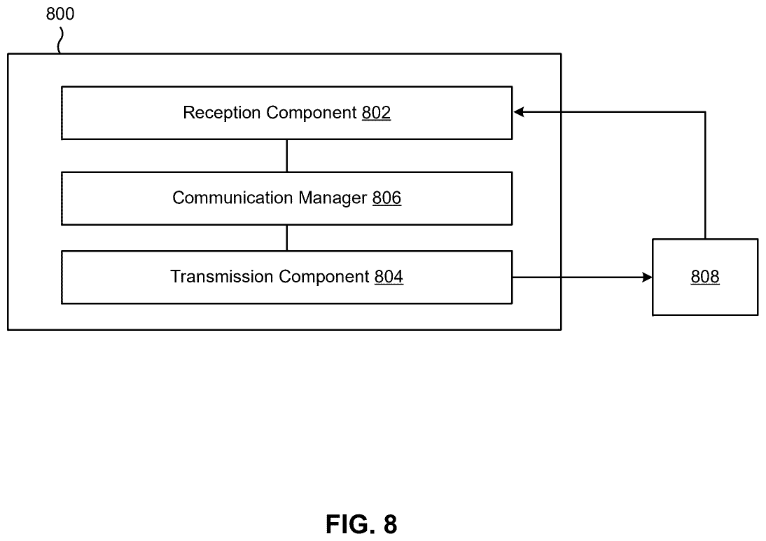

In some aspects, the UE 120 includes means for receiving, from a first network node, a configuration for OD-UL monitoring associated with one or more network nodes 110; means for transmitting, to the first network node, a first UL message requesting OD-UL monitoring at a second network node 110 of the one or more network nodes in accordance with the configuration; or means for transmitting, to the second network node 110, a second UL message in accordance with the configuration. The means for the UE 120 to perform operations described herein may include, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

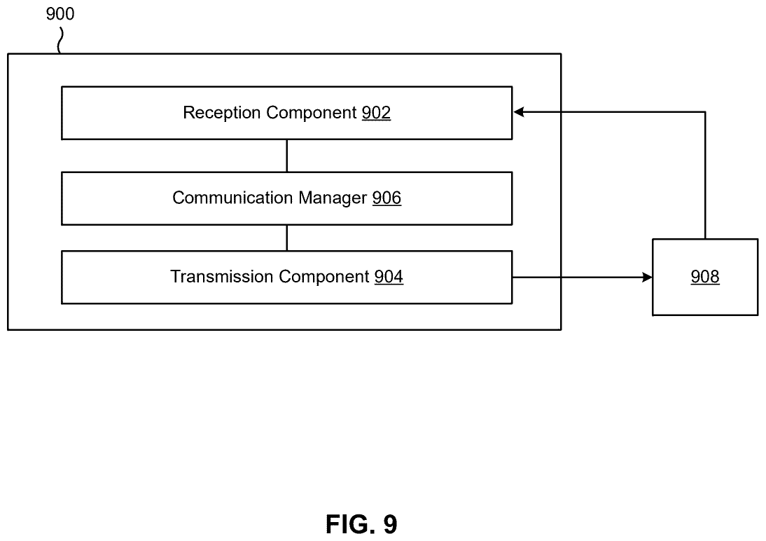

In some aspects, the network node 110 includes means for transmitting, to a UE 120, a configuration for OD-UL monitoring associated with one or more network nodes 110; means for receiving, from the UE, a UL message requesting OD-UL monitoring at a second network node 110 of the one or more network nodes 110 in accordance with the configuration; or means for transmitting, to the second network node 110, a message to initiate OD-UL monitoring in accordance with the UL message. The means for the network node to perform operations described herein may include one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

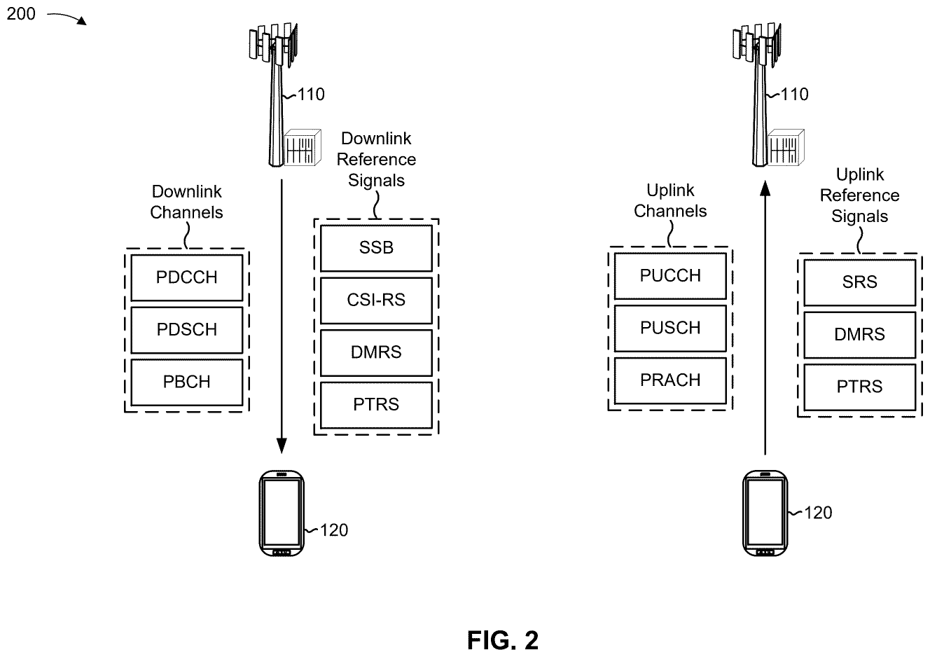

FIG. 2 is a diagram illustrating an example 200 of physical channels and reference signals in a wireless network. As shown in FIG. 2, downlink channels and downlink reference signals may carry information from a network node 110 to a UE 120, and UL channels and UL reference signals may carry information from a UE 120 to a network node 110.

As shown, a downlink channel may include a PDCCH that carries DCI, a PDSCH that carries downlink data, or a PBCH that carries system information, among other examples. In some aspects, PDSCH communications may be scheduled by PDCCH communications. As further shown, a UL channel may include a PUCCH that carries UCI, a PUSCH that carries UL data, or a PRACH used for initial network access, among other examples. In some aspects, the UE 120 may transmit ACK or NACK feedback (e.g., ACK/NACK feedback or ACK/NACK information) in UCI on the PUCCH or the PUSCH.

As further shown, a downlink reference signal may include an SSB, a CSI-RS, a DMRS, a positioning reference signal (PRS), or a PTRS, among other examples. As also shown, a UL reference signal may include an SRS, a DMRS, or a PTRS, among other examples.

An SSB may carry information used for initial network acquisition and synchronization, such as a PSS, an SSS, a PBCH, and a PBCH DMRS. An SSB is sometimes referred to as an SS/PBCH block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a PMI, a CRI, an LI, an RI, or an RSRP, among other examples. The network node 110 may use the CSI report to select transmission parameters for downlink communications to the UE 120, such as a number of transmission layers (e.g., a rank), a precoding matrix (e.g., a precoder), a MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and UL communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and UL communications (e.g., on the PUSCH).

A PRS may carry information used to enable timing or ranging measurements of the UE 120 based on signals transmitted by the network node 110 to improve observed time difference of arrival (OTDOA) positioning performance. In some cases, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for UL channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as UL CSI acquisition, downlink CSI acquisition for reciprocity-based operations, UL beam management, among other examples. The network node 110 may measure the SRSs, may perform channel estimation based at least in part on the measurements, and may use the SRS measurements to configure communications with the UE 120.

In some aspects, a first network node 110 (e.g., an anchor network node 110 or cell) may transmit, to the UE 120, a configuration for OD-UL monitoring associated with one or more network nodes (e.g., NES network nodes or cells). In some aspects, the first network node 110 may perform periodic transmissions of an SSB, and the SSB may include an indication of the configuration. Additionally, or alternatively, the first network node 110 may transmit a system information block (SIB), such as SIB1, that may indicate the configuration. In some cases, the first network node 110 may transmit an indication of an SIB1 for a second network node of the one or more network nodes. In some aspects, the configuration may indicate one or more physical PRACH resources of the first network node 110 for requesting OD-UL monitoring at the one or more network nodes 110. The one or more PRACH resources may include at least a first PRACH resource dedicated for requesting OD-UL monitoring at the second network node 110 of the one or more network nodes. In some aspects, the UE 120 may transmit a message requesting OD-UL monitoring at the second network node 110 via the first PRACH resource. In some aspects, the message may indicate the second network node 110 or a beam for communicating with the second network node 110. The first network node 110 may receive the message and may transmit one or more messages (e.g., via a backhaul link) to the second network node 110 to activate OD-UL at the second network node 110. In some aspects, the UE 120 may then perform communications with the second network node 110 in accordance with the activation of the OD-UL. For instance, the UE 120 may transmit a UL message to the second network node 110 in accordance with a RACH-less access procedure.

As indicated above, FIG. 2 is provided as an example. Other examples may differ from what is described with regard to FIG. 2.

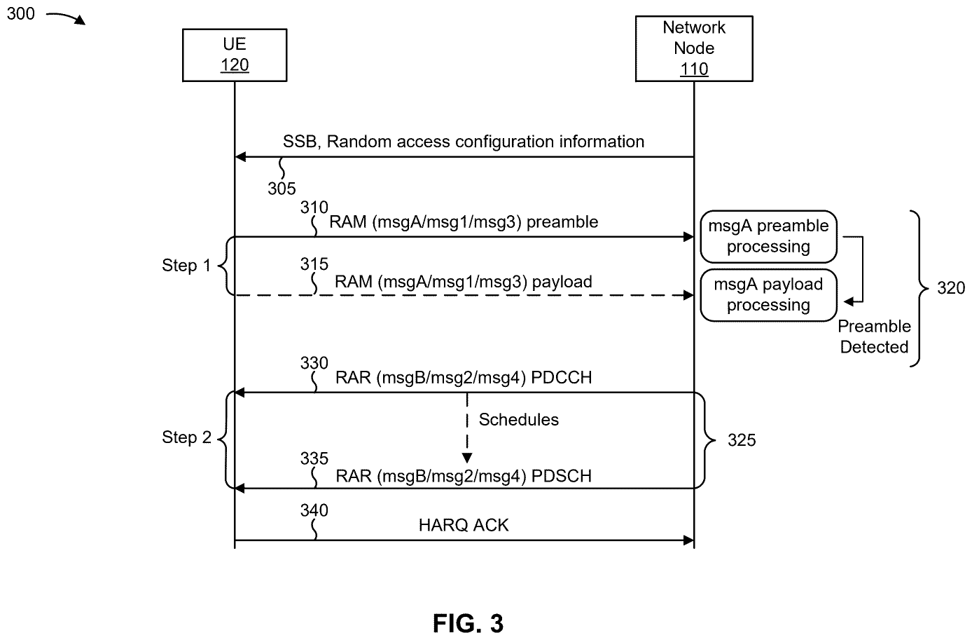

FIG. 3 is a diagram illustrating an example 300 of a two-step RACH procedure and a four-step RACH procedure. As shown in FIG. 3, a network node 110 and a UE 120 may communicate with one another to perform the two-step RACH procedure and/or the four-step RACH procedure.

As shown by reference number 305, the network node 110 may transmit, and the UE 120 may receive, one or more SSBs and/or random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step RACH procedure and/or the four-step RACH procedure, such as one or more parameters for transmitting a random access message (RAM) and/or receiving a random access response (RAR) responsive to the RAM.

As shown by reference number 310, in the example of a two-step RACH procedure, the UE 120 may transmit, and the network node 110 may receive, a RAM preamble. As shown by reference number 315, in the example of a two-step RACH procedure, the UE 120 may transmit, and the network node 110 may receive, a RAM payload. As shown, the UE 120 may transmit the RAM preamble and the RAM payload to the network node 110 as part of an initial (or first) step of the two-step RACH procedure. In some aspects, the RAM may be referred to as message A, msgA, a first message, or an initial message in a two-step RACH procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (Msg1) and message 3 (Msg3) of a four-step RACH procedure, which is described in more detail below. In some aspects, the RAM preamble may include some or all contents of message 1 (e.g., a PRACH preamble), and the RAM payload may include some or all contents of message 3 (e.g., a UE identifier, UCI, and/or a PUSCH) transmission.

As shown by reference number 310 and/or reference number 315, in the example of a four-step RACH procedure, the UE 120 may transmit a RAM, which may include a preamble (sometimes referred to as a random access preamble, a PRACH preamble, or a RAM preamble). The message that includes the preamble may be referred to as a message 1, Msg1, MSG1, a first message, or an initial message in a four-step RACH procedure. The random access message may include a random access preamble identifier.

As shown by reference number 310 and/or reference number 315, in the example of a four-step RACH procedure, the UE 120 may transmit an RRC connection request message. The RRC connection request message may be referred to as message 3, Msg3, MSG3, or a third message of a four-step RACH procedure. In some aspects, the RRC connection request may include a UE identifier, UCI, and/or a PUSCH communication (e.g., an RRC connection request).

As shown by reference number 320, in the example of a two-step RACH procedure, the network node 110 may receive the RAM preamble transmitted by the UE 120. If the network node 110 successfully receives and decodes the RAM preamble, the network node 110 may then receive and decode the RAM payload.

As shown by reference number 325, in the example of a two-step RACH procedure, the network node 110 may transmit an RAR (sometimes referred to as an RAR message). As shown, the network node 110 may transmit the RAR message as part of a second step of the two-step RACH procedure. In some aspects, the RAR message may be referred to as message B, msgB, or a second message in a two-step RACH procedure. The RAR message may include some or all of the contents of message 2 (Msg2) and message 4 (Msg4) of the four-step RACH procedure. In some aspects, the RAR message may include the detected PRACH preamble identifier, the detected UE identifier, a timing advance value, and/or contention resolution information.

As shown by reference number 330, in the example of a two-step RACH procedure, as part of the second step of the two-step RACH procedure, the network node 110 may transmit a PDCCH communication for the RAR. The PDCCH communication may schedule a PDSCH communication that includes the RAR. In some aspects, the PDCCH communication may indicate a resource allocation (e.g., in DCI) for the PDSCH communication.

As shown by reference number 330 and/or reference number 335, in the example of a four-step RACH procedure, the network node 110 may transmit an RAR as a reply to the preamble. The message that includes the RAR may be referred to as message 2, Msg2, MSG2, or a second message in a four-step RACH procedure. In some aspects, the RAR may indicate the detected random access preamble identifier (e.g., received from the UE 120 in Msg1). Additionally, or alternatively, the RAR may indicate a resource allocation to be used by the UE 120 to transmit message 3 (Msg3).

In some aspects, as part of the second step of the four-step RACH procedure, the network node 110 may transmit a PDCCH communication for the RAR. The PDCCH communication may schedule a PDSCH communication that includes the RAR. In some aspects, the PDCCH communication may indicate a resource allocation for the PDSCH communication. Also as part of the second step of the four-step RACH procedure, the network node 110 may transmit the PDSCH communication for the RAR, as scheduled by the PDCCH communication. The RAR may be included in a MAC protocol data unit (PDU) of the PDSCH communication.

As shown by reference number 335, in the example of a two-step RACH procedure, as part of the second step of the two-step RACH procedure, the network node 110 may transmit the PDSCH communication for the RAR, as scheduled by the PDCCH communication. The RAR may be included in a MAC PDU of the PDSCH communication. As shown by reference number 340, if the UE 120 successfully receives the RAR, the UE 120 may transmit a HARQ ACK.

As shown by reference number 330 and/or 335, in the example of a four-step RACH procedure, the network node 110 may transmit an RRC connection setup message. The RRC connection setup message may be referred to as message 4, Msg4, MSG4, or a fourth message of a four-step RACH procedure. In some aspects, the RRC connection setup message may include the detected UE identifier, a timing advance value, and/or contention resolution information.

As shown by reference number 340, if the UE 120 successfully receives the RRC connection setup message, the UE 120 may transmit a HARQ ACK. The UE 120 may transmit the HARQ-ACK message to indicate successful completion of the RACH procedure.

In some aspects, a first network node 110 (e.g., an anchor network node 110 or cell) may transmit, to the UE 120, a configuration for OD-UL monitoring associated with one or more network nodes (e.g., NES network nodes or cells). In some aspects, the configuration may indicate one or more physical PRACH resources of the first network node 110 for requesting OD-UL monitoring at the one or more network nodes 110. The one or more PRACH resources may include at least a first PRACH resource dedicated for requesting OD-UL monitoring at a second network node 110 of the one or more network nodes. In some aspects, the UE 120 may transmit a message requesting OD-UL monitoring at the second network node 110 via the first PRACH resource. In some aspects, the message may be a RAM preamble, such as the Msg1, a RAM payload, such as a Msg3, or a MsgA. The UE 120 may receive the message and may transmit one or more messages (e.g., via a backhaul link) to the second network node 110 to activate OD-UL at the second network node 110. In some aspects, the UE 120 may receive an RAR message from the first network node 110 or the second network node 110. In some aspects, the UE 120 may then perform communications with the second network node 110 in accordance with the activation of the OD-UL. For instance, the UE 120 may transmit a UL message to the second network node 110 in accordance with a RACH-less access procedure after receiving the RAR message.

As indicated above, FIG. 3 is provided as an example. Other examples may differ from what is described with regard to FIG. 3.

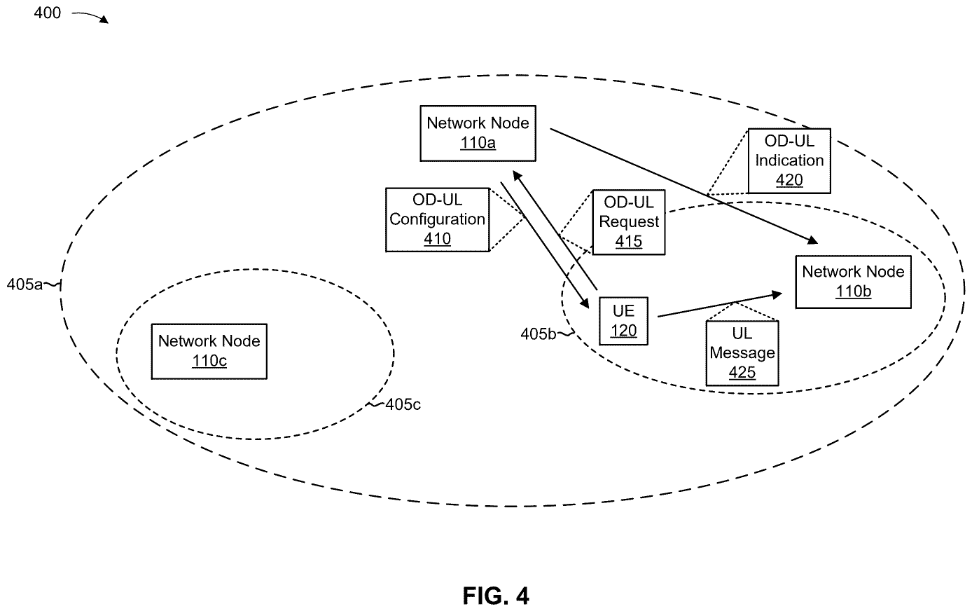

FIG. 4 is a diagram illustrating an example 400 associated with access procedures with OD-UL monitoring. As shown in FIG. 4, a wireless communication network (e.g., wireless communication network 100) may include a UE 120, a first network node 110a (e.g., an anchor network node or cell), a second network node 110b (e.g., an NES network node or cell), and a third network node 110c (e.g., an NES network node or cell), which may support communications with one another. In some cases, the first network node 110a, the second network node 110b, the third network node 110c, or a combination thereof, may be collocated. For example, the first network node 110a and the second network node 110b may be part of a same network node 110 (e.g., may be cells that share a same gNB), or may represent components of a same network node 110.

In some aspects, the network nodes 110 may be associated with a coverage area 405. For instance, the first network node 110a may operate within a coverage area 405a (e.g., may support communications for UEs 120 within the coverage area 405a), the second network node 110b may operate within a coverage area 405b, and the third network node 110c may operate within a coverage area 405c. In some aspects, the coverage area 405a of the first network node 110a may be larger than the coverage area 405b and the coverage area 405c. In some cases, the first network node 110a may operate in accordance with a first frequency range (e.g., FR1) that may be associated with lower frequencies than a second frequency range (e.g., FR2, FR3, other frequency ranges, or a combination thereof) used by the second network node 110b and the third network node 110c. In some cases, the coverage area 405b and the coverage area 405c may be within the coverage area 405a. In some cases, a network node 110 may communicate with another network node 110 by sending one or more backhaul messages (e.g., via a backhaul link). In some aspects, the first network node 110a may communicate with the second network node 110b via a backhaul link.

In some aspects, the first network node 110a may transmit, and the UE 120 may receive, one or more messages indicating an OD-UL configuration 410 for requesting OD-UL monitoring at one or more network nodes 110 (e.g., NES network nodes or cells), such as the second network node 110b and the third network node 110c. In some cases, the first network node 110a may periodically transmit an SSB or an SIB (e.g., SIB1) that may indicate the OD-UL configuration 410. Additionally, or alternatively, the first network node 110a may periodically transmit an SIB1 corresponding to the second network node 110b, which may reduce energy consumption at the second network node 110b.

In some aspects, the OD-UL configuration 410 may include an indication of one or more PRACH resources (e.g., PRACH preambles, time occasions, frequency resources, or a combination thereof). In some cases, the OD-UL configuration 410 may indicate dedicated PRACH resources of the first network node 110a for requesting OD-UL monitoring at each of the one or more network nodes 110. In some aspects, the OD-UL configuration 410 may include one or more PRACH resources for requesting OD-UL monitoring at the second network node 110b. Additionally, or alternatively, the OD-UL configuration 410 may include an indication of one or more groups of network nodes 110, and the OD-UL configuration 410 may link PRACH resources to groups of network nodes 110. In some aspects, the OD-UL configuration 410 may include an indication of a group of network nodes 110 including the second network node 110b and the third network node 110c, and a PRACH resource to be used by the UE 120 to request OD-UL monitoring at the second network node 110b or at the third network node 110c.

Additionally, or alternatively, the OD-UL configuration 410 may include one or more PRACH resources for requesting an on-demand SIB (e.g., SIB1) transmission from the one or more network nodes 110. In some aspects, the OD-UL configuration 410 may include an indication of the one or more network nodes 110 that support OD-UL monitoring (e.g., of one or more NES cells that support OD-UL monitoring).

Additionally, or alternatively, the OD-UL configuration 410 may include an indication of one or more triggering conditions for requesting OD-UL monitoring. When the UE 120 detects that a triggering condition has occurred, the UE 120 may request OD-UL monitoring at a corresponding network node 110. In some aspects, the one or more triggering conditions may include a satisfaction of an absolute signal quality threshold (e.g., an RSRP threshold, an RSRQ threshold, or a signal-to-interference-and-noise ratio (SINR) threshold) by a signal quality of signaling received from the one or more network nodes 110. Additionally, or alternatively, the one or more triggering conditions may include a satisfaction of a relative signal quality threshold (e.g., an RSRP threshold, an RSRQ threshold, or an SINR threshold). In some cases, a triggering condition may occur when a signal quality of signaling from the second network node 110b is greater than a signal quality of signaling from the first network node 110a by the relative signal threshold (e.g., as measured by the UE 120). Additionally, or alternatively, the one or more triggering conditions may include reception, by the UE 120, of paging (e.g., from the first network node 110a) associated with downlink data being available for reception, or arrival of UL data for transmission at the UE 120. Additionally, or alternatively, the one or more triggering conditions may include a satisfaction of an arrival data size threshold (e.g., when data that has arrived for transmission satisfies a threshold), or arrival of a type of UL data for transmission at the UE 120.

Additionally, or alternatively, the OD-UL configuration 410 may include an indication of a UL monitoring status at the one or more network nodes 110. In some cases, the OD-UL configuration 410 may include an indication of whether the second network node 110b is monitoring for UL communications periodically or is not monitoring for UL communications. Additionally, or alternatively, the OD-UL configuration 410 may include an indication of a time for the UE 120 to begin an access procedure (e.g., a RACH-less access procedure) with a network node 110. In some cases, the OD-UL configuration 410 may include an indication of a duration, such that the UE 120 is configured to begin the access procedure after the duration elapses from the transmission of a message via a corresponding PRACH request (e.g., an OD-UL request 415) or from reception of a message from the first network node 110a (e.g., an RAR message). Additionally, or alternatively, the OD-UL configuration 410 may include a timing advance value associated with at least one network node 110 of the one or more network nodes 110, or the OD-UL configuration 410 may include a time difference between the first network node 110a and at least one network node 110 of the one or more network nodes 110 (e.g., for unsynchronized network nodes 110).

In some aspects, the one or more messages indicating the OD-UL configuration 410 may be beam-specific, and the first network node 110a may transmit multiple configuration messages using different beams. Each configuration message may indicate different parameter values. In some cases, the first network node 110a may transmit a first configuration message via a first beam (e.g., a first SSB beam), and the first configuration message may include configuration information (e.g., a first OD-UL configuration 410) for a first group of one or more network nodes 110. Additionally, or alternatively, the first network node 110a may transmit a second configuration message via a second beam (e.g., a second SSB beam), and the second configuration message may include configuration information (e.g., a second OD-UL configuration 410) for a second group of one or more network nodes 110. In some aspects, the one or more messages (or the one or more configuration messages) may be broadcast messages (e.g., sent via SIB1 or another SIB), or the one or more messages may be UE-specific messages (e.g., an RRC release message, an RRC reconfiguration message, or a MAC-CE message).

In some aspects, the UE 120 may be configured to transmit an OD-UL request 415. The UE 120 may transmit the OD-UL request 415 to request OD-UL monitoring at one or more network nodes 110 (e.g., NES network nodes or cells) detected by the UE 120. In some aspects, the UE 120 may detect a network node 110 in accordance with reception of a discovery signal or an SSB from the network node 110. Additionally, or alternatively, the UE 120 may detect the second network node 110b based on a signal quality of the discovery signal or the SSB satisfying a threshold (e.g., an absolute signal quality threshold or a relative signal quality threshold, which may be indicated by the OD-UL configuration 410).

Additionally, or alternatively, the UE 120 may request OD-UL monitoring at one or more network nodes 110 that are not monitoring for UL communications. For instance, the UE 120 may determine that the second network node 110b is not monitoring UL communications in accordance with the discovery signal, SSB, or SIB transmitted by the second network node 110b. Additionally, or alternatively, the first network node 110a may transmit an indication of whether the second network node 110b is monitoring for UL communications, such as via the OD-UL configuration 410 or a transmission of an SIB corresponding to the second network node 110b. Accordingly, in some aspects, the UE 120 may transmit the OD-UL request 415 to request OD-UL monitoring at the second network node 110b.

In some aspects, the UE 120 may transmit the OD-UL request 415 in accordance with one or more triggering conditions (e.g., payload size of incoming data satisfying a threshold), which may be configured via the OD-UL configuration 410, as described herein. Additionally, or alternatively, the UE 120 may be configured to transmit the OD-UL request 415 in accordance with a type of the UE 120 or a capability of the UE 120. For instance, some types of UEs 120, which may be associated with different processing or energy capabilities, may be configured such as to trigger request of OD-UL monitoring when a network node 110 that supports OD-UL monitoring (e.g., and is not currently monitoring for UL communications) is detected.

In some aspects, the OD-UL request 415 may be transmitted via a corresponding PRACH resource dedicated for requesting OD-UL monitoring as indicated by the OD-UL configuration 410. For instance, to request OD-UL monitoring at the second network node 110b, the UE 120 may transmit a message via a PRACH resource dedicated for requesting OD-UL monitoring at the second network node 110b (or a group of network nodes 110 including the second network node 110b) in accordance with the OD-UL configuration 410. Accordingly, when the first network node 110a receives the OD-UL request 415 via the dedicated PRACH resource, the network node 110a may recognize the request for OD-UL monitoring at the second network node 110b. In some aspects, the OD-UL request may be transmitted while the UE 120 is operating in an idle or inactive (e.g., RRC idle or RRC inactive) mode.

In some aspects, the UE 120 may transmit the OD-UL request 415 to the first network node 110a via a PRACH preamble message (e.g., a Msg1 or RAM preamble). In some cases, after transmitting the PRACH preamble message, the UE 120 may monitor for an RAR message from the first network node 110a within an RAR window (e.g., a configured duration after the PRACH preamble message). When the UE 120 receives the RAR message from the first network node 110a and the RAR message includes an expected identifier (e.g., a PRACH preamble identifier or “PRAID” included in the PRACH preamble message), the UE 120 may consider the transmission of the OD-UL request 415 to be successful and does not perform a retransmission. In some cases, the UE 120 may be configured to retransmit the PRACH preamble message to the first network node 110a when the transmission is unsuccessful, such as when the UE 120 does not receive the RAR message during the RAR window or when the RAR message does not include the expected identifier. Additionally, or alternatively, after transmitting the PRACH preamble message, the UE 120 may be configured to monitor for an RAR message (e.g., a Msg2) from the second network node 110b. The UE 120 may follow similar steps for retransmitting the PRACH preamble message, such as when the RAR message is not received from the second network node 110b within the RAR window or when the RAR message does not include the expected identifier.

Additionally, or alternatively, the UE 120 may be configured to transmit the OD-UL request 415 via a payload message (e.g., a Msg3 or RAM payload). In some aspects, the UE 120 may perform an initial portion of a RACH procedure (e.g., an exchange of one or more preamble messages, random access response messages, or payload messages, such as a Msg1, a Msg2, or a Msg3 exchange) with the first network node 110a, and the Msg3 may include the OD-UL request 415. Additionally, or alternatively, the UE 120 may include the OD-UL request 415 in a MsgA (e.g., a preamble and payload message) of a 2-step RACH procedure. In some aspects, the first network node 110a and the second network node 110b may exchange information associated with the UE 120, such as a UE identifier or identity, or an establishment cause associated with the request of the UE 120 (e.g., a type of data).

In some aspects, the OD-UL request 415 may include an indication of one or more detected network nodes 110 (e.g., one or more identifiers), or an indication of detected SSBs of one or more network nodes 110. Additionally, or alternatively, the OD-UL request 415 may include an indication for requesting, from one or more network nodes 110, OD-UL monitoring, OD-SIB transmissions (e.g., SIB1 transmissions), or both OD-UL monitoring and OD-SIB transmissions. For instance, a first PRACH resource indicated by the OD-UL configuration 410 may be configured for triggering OD-SIB transmissions (e.g., by the first network node 110a) of SIBs for one or more network nodes 110 corresponding to the first PRACH resource and OD-UL monitoring by the one or more network nodes 110. In some aspects, when the first network node 110a receives the OD-UL request 415 via a PRACH resource corresponding to the second network node 110b, the first network node 110a may transmit an SIB (e.g., SIB1) corresponding to the second network node 110b and may notify the second network node 110b to begin OD-UL monitoring via an OD-UL indication 420.

In some aspects, the OD-UL indication 420 is transmitted (e.g., via a backhaul link) from the first network node 110a to the second network node 110b. Additionally, or alternatively, the first network node 110a may transmit the OD-UL indication 420 to other network nodes 110 associated with the dedicated PRACH resource used for transmission of the OD-UL request 415. Additionally, or alternatively, the first network node 110a may determine network nodes 110 to indicate to enable OD-UL monitoring in accordance with a mapping between the SSB and PRACH occasions. For instance, the network node 110 may determine that a PRACH resource used for transmission of the OD-UL request 415 corresponds to a first set of one or more SSB beams, and the first network node 110a may transmit the OD-UL indication 420 to the second network node 110b in accordance with the coverage area 405b corresponding to the first set of one or more SSB beams. Accordingly, in some aspects, the second network node 110b may begin monitoring for UL communications in accordance with receiving the OD-UL indication 420.

In some aspects, after the first network node 110a transmits the OD-UL indication 420 to one or more network nodes 110, the first network node 110a may update a UL monitoring status of the one or more network nodes 110 to reflect the change. For instance, the first network node 110a may transmit an updated OD-UL configuration 410 that indicates the updated UL monitoring status (e.g., an enabled status) of the one or more network nodes 110.

In some aspects, when OD-UL monitoring is enabled at the second network node 110b, the second network node 110b may monitor only for Msg3 transmissions (e.g., RAM payloads), which may be referred to as partial random access message monitoring. Additionally, or alternatively, the second network node 110b may monitor for Msg3 transmissions and for PRACH messages (e.g., Msg1 transmissions), which may be referred to as full random access message monitoring. In some cases, the second network node 110b may monitor for Msg3 transmissions and temporarily monitor for PRACH messages.

In some aspects, after OD-UL monitoring has been enabled at the second network node 110b, the UE 120 may transmit a UL message 425 to the second network node 110b. In some cases, the UE 120 may initiate a RACH-less access procedure (e.g., a partial RACH access procedure that may not include Msg1, Msg 2, or Msg A exchange) with the second network node 110b, which may be used for connection setup or data transmission with the second network node 110b. In cases where multiple network nodes 110 are associated with the PRACH resource used for requesting OD-UL monitoring, the UE 120 may select the network node 110 having the best (e.g., highest) signal quality to proceed with the RACH-less access procedure, or a network node 110 having a nearest proximity to the UE 120. In some cases, the UL message 425 may be an example of a Msg3 or a payload message.

Additionally, or alternatively, the UE 120 may initiate the RACH-less access procedure (e.g., by transmitting the UL message 425) after a duration (e.g., a time gap or delta) following the reception of an RAR message (e.g., from the first network node 110a or the second network node 110b). In some aspects, the duration may be indicated by the first network node 110a in the OD-UL configuration 410 or may be a standardized duration. Additionally, or alternatively, the duration may be time-specific, location-specific, or cell-specific (e.g., network node-specific). For instance, the OD-UL configuration 410 may indicate multiple durations for use depending on the selected network node 110, the location of the UE 120, or the time at which the RACH-less access procedure is initiated. In some cases, the first network node 110a may communicate the duration (or a corresponding duration) to other network nodes 110 via backhaul interfaces (e.g., F1-AP or Xn). This may allow the network nodes 110 to be synchronized regarding the timing of the RACH-less access procedure, facilitating efficient coordination and resource allocation within the wireless communication network.

In some aspects, after receiving the UL message 425 from the UE 120, the second network node 110b may notify (e.g., via a backhaul link) the first network node 110a, other network nodes 110, or a combination thereof, of the successful reception of the UL message 425. In some cases, notifying the other network nodes 110 may allow other network nodes 110 associated with the same PRACH resource for requesting OD-UL monitoring to stop UL monitoring, thereby conserving energy and preserving network resources. In some aspects, the first network node 110a may indicate that the other network nodes 110 associated with the same PRACH resource are to disable OD-UL monitoring. In some aspects, after the first network node 110a transmits an indication to disable UL monitoring for one or more network nodes 110, the first network node 110a may update a UL monitoring status of the one or more network nodes 110 to reflect the change. For instance, the first network node 110a may transmit an updated OD-UL configuration 410 that indicates the updated UL monitoring status (e.g., a disabled status) of the one or more network nodes 110.

In some aspects, when the second network node 110b does not receive a UL message from the UE 120 within a duration (e.g., configured to the second network node 110b, such as by the OD-UL indication 420), the second network node 110b may stop monitoring for UL communications. In some cases, the second network node 110b may transmit an RAR message to the UE 120 in accordance with receiving the UL message 425.

In some aspects, when the transmission of the UL message 425 is unsuccessful (e.g., due to contention or other failure conditions), the UE 120 may be configured to resend a PRACH message (e.g., the OD-UL request 415) to the first network node 110a. Additionally, or alternatively, the UE 120 may be configured to send a PRACH message to the second network node 110b directly, such as in cases when the second network node 110b monitors for PRACH messages when OD-UL monitoring is enabled.

In some aspects, upon completion of communication with all UEs 120 (e.g., all UEs indicated in the OD-UL indication 420 or that sent a UL message during the duration), the second network node 110b may cease UL monitoring. In some cases, when the second network node 110b is configured to transmit an indication of the UL monitoring status of the second network node 110b, the second network node 110b may begin transmitting an updated UL monitoring status after the UL monitoring is changed.

In some aspects, the UE 120 may transmit the UL message 425 to the second network node 110b in accordance with a timing advance of the second network node 110b. In cases where the first network node 110a and the second network node 110b are synchronized, the UE 120 may estimate the TA of the second network node 110b or use the same TA as used for the first network node 110a without receiving additional information from the first network node 110a. Additionally, or alternatively, when the first network node 110a and the second network node 110b are not synchronized, the UE 120 may receive information from the first network node 110a for estimating or determining the TA for the second network node 110b. In some aspects, the first network node 110a may indicate a value corresponding to the difference (e.g., a delta) between the TA of the first network node 110a and the TA of the second network node 110b. In some cases, the value may be indicated to the UE 120 in the OD-UL configuration 410 transmitted by the first network node 110a.

Additionally, or alternatively, the first network node 110a may estimate the TA for use by the UE 120. In some aspects, when the UE 120 sends the OD-UL request 415, the UE 120 may include an indication of a beam to be used for communications with the second network node 110b, an identifier of the second network node 110b, or a combination thereof (e.g., determined by the UE 120 in accordance with one or more measurements in an idle or inactive mode). The first network node 110a may estimate the TA for use by the UE 120 in accordance with the information provided in the OD-UL request 415. In some aspects, the first network node 110a may indicate the estimated TA of the second network node 110b in the RAR message sent to the UE 120 (e.g., in response to the OD-UL request 415). In some cases, such as if the Msg3 is to be sent by the UE 120 to the first network node 110a, the first network node 110a may additionally indicate a TA of the first network node 110a.

As indicated above, FIG. 4 is provided as an example. Other examples may differ from what is described with respect to FIG. 4.

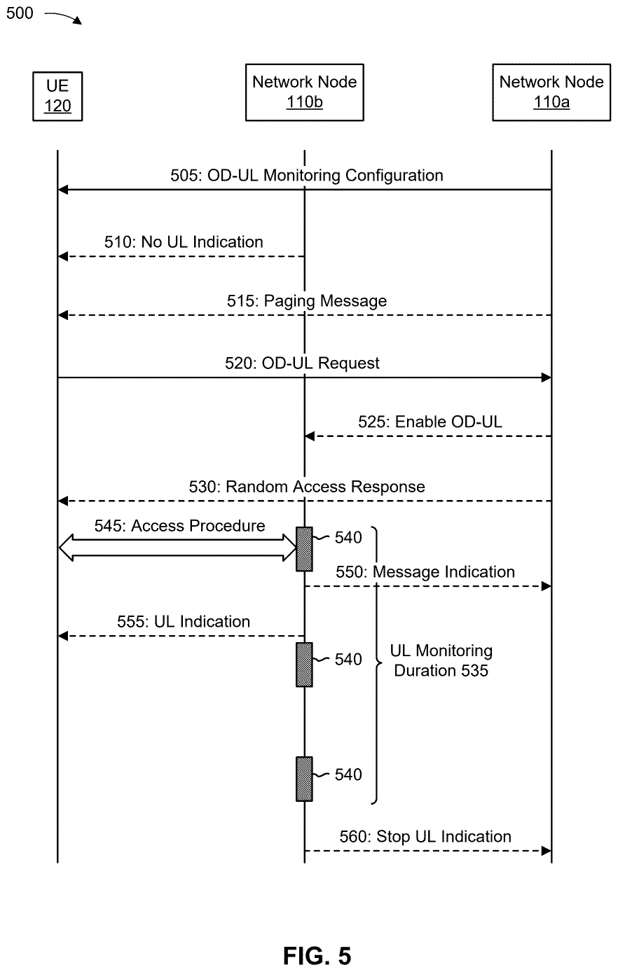

FIG. 5 is a diagram illustrating an example 500 associated with access procedures with OD-UL monitoring. As shown in FIG. 5, the example 500 may include a UE 120, a first network node 110a (e.g., an anchor network node or cell), and a second network node 110b (e.g., an NES network node or cell), which may support communications with one another. In some examples, communications between the first network node 110a and the second network node 110b may be performed via a backhaul link. In some cases, the first network node 110a and the second network node 110b may be collocated. For example, the first network node 110a and the second network node 110b may be part of a same network node 110 (e.g., may be cells that share a same gNB), or may represent components of a same network node 110. Additionally, or alternatively, functions performed by the first network node 110a and the second network node 110b may instead be performed by a single network node 110 (e.g., by components of the single network node 110, individually or collectively).

As shown by reference number 505, the first network node 110a may transmit am OD-UL monitoring configuration (e.g., OD-UL configuration 410) to the UE 120, as described herein. In some aspects, the OD-UL monitoring configuration may include one or more PRACH resources, one or more triggering conditions, or a combination thereof, that may be used by the UE 120 to request OD-UL monitoring at one or more network nodes 110, including the second network node 110b. Additionally, or alternatively, the OD-UL monitoring configuration may specify a current UL monitoring status of the one or more network nodes 110 or one or more TA values that may be used by the UE 120 to initiate access procedures with the network nodes 110.

As shown by reference number 510, the second network node 110b may transmit an indication to the UE 120 indicating an OD-UL status of the second network node 110b. For example, the second network node 110b may indicate that UL monitoring is disabled at the second network node 110b. In some examples, the indication may be sent via a discovery reference signal (DRS) (e.g., a discovery signal), such as an SSB.

As shown by reference number 515, the first network node 110a may transmit a paging message to the UE 120 that may indicate that downlink data is available for the UE 120. Additionally, or alternatively, the paging message may serve as a trigger (e.g., reception of the paging message may be a triggering condition) for the UE 120 to initiate further communication actions, such as requesting OD-UL.

As shown by reference number 520, the UE 120 may transmit, to the first network node 110a, an OD-UL request in accordance with the OD-UL monitoring configuration. For instance, the UE 120 may transmit the OD-UL request using a dedicated PRACH resource indicated in the OD-UL monitoring configuration. In some aspects, the UE 120 may transmit the OD-UL request based on detection of at least one triggering condition, such as satisfaction of a signal quality threshold (e.g., absolute or relative, as described herein), an arrival of UL data for transmission, or reception of the paging message. In some aspects, the OD-UL request may include an indication of one or more network nodes 110, such as the second network node 110b, for which OD-UL monitoring is requested (e.g., by including one or more NES cell identifiers). Additionally, or alternatively, the OD-UL request may include an indication of a beam to be used for communications with the second network node 110b.

As shown by reference number 525, the first network node 110a may send an indication, to the second network node 110b, to enable OD-UL monitoring at the second network node 110b. In some aspects, the indication may cause the second network node 110b to begin monitoring for UL communications from the UE 120 (and other UEs 120). In some cases, the first network node 110a may determine which network nodes 110 to notify based on a mapping between SSBs and PRACH occasions, the OD-UL request (e.g., a PRACH resource used for the OD-UL request, or an indication in the OD-UL request), or a combination thereof, ensuring that the appropriate nodes are activated for UL monitoring. In some aspects, the first network node 110a may additionally send an indication to one or more other network nodes 110 to enable OD-UL monitoring, such as network nodes 110 associated with a same PRACH resource as the second network node 110b.

As shown by reference number 530, the first network node 110a may transmit an RAR message (e.g., a Msg3) to the UE 120. The RAR message may provide the UE 120 with information, such as timing advance values, that may facilitate the subsequent transmission of UL messages with the second network node 110b.

In some aspects, the second network node 110b may enable UL monitoring for a UL monitoring duration 535. In some cases, the UL monitoring duration 535 may be dynamic. For instance, the second network node 110b may adjust the UL monitoring duration 535 based on whether uplink messages are received from UEs 120 or a quantity of uplink messages that are received. In some cases, the second network node 110b may cease UL monitoring after receiving UL messages from the UE 120, or when no UL messages are received from UEs 120 within the UL monitoring duration 535 (or another duration). In some aspects, when OD-UL monitoring is enabled at the second network node 110b, the second network node 110b may periodically monitor for UL communications during one or more windows 540. In some aspects, the one or more windows 540 may be indicated to the UE 120, such as via the OD-UL monitoring configuration or the RAR message.

As shown by reference number 545, the UE 120 may initiate an access procedure (e.g., a RACH-less access procedure) with the second network node 110b. In some aspects, the UE 120 may transmit a UL message (e.g., UL message 425) to the second network node 110b. In some cases, the UE 120 may transmit the UL message during a window 540 of the one or more windows 540.

As shown by reference number 550, the second network node 110b may transmit an indication, to the first network node 110a, of reception of the UL message from the UE 120. For instance, the second network node 110b may transmit the indication after successful reception of the UL message 425. The indication may allow other network nodes 110 associated with the same PRACH resource to stop UL monitoring, thereby improving network resource usage and conserving energy. For instance, the first network node 110a may transmit an indication to the one or more other network nodes 110 to disable OD-UL monitoring.

As shown by reference number 555, the second network node 110b transmits an indication to the UE 120 that UL monitoring is active. In some examples, the indication may be sent via a DRS (e.g., a discovery signal), such as an SSB. In some cases, the indication may indicate the one or more windows 540.

As shown by reference number 560, the second network node 110b may transmit an indication to the first network node 110a that the second network node 110b has stopped UL monitoring. In some cases, the second network node 11b may transmit the indication after the second network node 110b has successfully communicated with the UE 120 and any other UEs 120, or after the second network node 110b has not received additional UL messages (e.g., within a duration).

Accordingly, the second network node 110b may conserve energy by eliminating the need for periodic UL monitoring, as the second network node 110b may instead monitor for UL communications when UEs 120 are connected to the second network node 110b or when the second network node 110b is triggered by the first network node 110a to enable UL monitoring.

As indicated above, FIG. 5 is provided as an example. Other examples may differ from what is described with respect to FIG. 5. For example, additional messages not shown may be added, or some messages may be performed in a different order than shown or may be omitted.

FIG. 6 is a diagram illustrating an example process 600 performed, for example, at a UE (e.g., UE 120) or an apparatus of a UE. Example process 600 is an example where the apparatus or the UE performs operations associated with initial access with OD-UL monitoring.

As shown in FIG. 6, in some aspects, process 600 may include receiving, from a first network node, a configuration for OD-UL monitoring associated with one or more network nodes (block 610). For example, the UE (e.g., using reception component 802 or communication manager 806, depicted in FIG. 8) may receive, from a first network node, a configuration for OD-UL monitoring associated with one or more network nodes, as described above.

As further shown in FIG. 6, in some aspects, process 600 may include transmitting, to the first network node, a first UL message requesting OD-UL monitoring at a second network node of the one or more network nodes in accordance with the configuration (block 620). For example, the UE (e.g., using transmission component 804 or communication manager 806, depicted in FIG. 8) may transmit, to the first network node, a first UL message requesting OD-UL monitoring at a second network node of the one or more network nodes in accordance with the configuration, as described above.

As further shown in FIG. 6, in some aspects, process 600 may include transmitting, to the second network node, a second UL message in accordance with the configuration (block 630). For example, the UE (e.g., using transmission component 804 or communication manager 806, depicted in FIG. 8) may transmit, to the second network node, a second UL message in accordance with the configuration, as described above.

Process 600 may include additional aspects, such as any single aspect or any combination of aspects described below or in connection with one or more other processes described elsewhere herein.

In a first aspect, the configuration indicates one or more PRACH resources for requesting OD-UL monitoring at the one or more network nodes.

In a second aspect, alone or in combination with the first aspect, the first UL message is transmitted to the first network node via a first PRACH resource of the one or more PRACH resources dedicated for requesting OD-UL monitoring at the second network node.

In a third aspect, alone or in combination with one or more of the first and second aspects, process 500 includes receiving, from the first network node, one or more reference signals indicating that UL monitoring is disabled for the second network node, wherein transmitting the first UL message is in accordance with the UL monitoring being disabled.

In a fourth aspect, alone or in combination with one or more of the first through third aspects, process 500 includes receiving, from the first network node, one or more reference signals indicating that UL monitoring is enabled for the second network node based at least in part on transmitting the first UL message to the first network node, wherein transmitting the second UL message is in accordance with the UL monitoring being enabled.

In a fifth aspect, alone or in combination with one or more of the first through fourth aspects, the first UL message indicates one or more beams for communications with the second network node, an identifier associated with the second network node, or a combination thereof.

In a sixth aspect, alone or in combination with one or more of the first through fifth aspects, the configuration indicates a timing advance difference between the second network node and the first network node.

In a seventh aspect, alone or in combination with one or more of the first through sixth aspects, process 500 includes receiving, from the first network node, a response message based at least in part on the first UL message, wherein the response message indicates a timing advance associated with the second network node.

In an eighth aspect, alone or in combination with one or more of the first through seventh aspects, the configuration indicates whether OD-UL monitoring for the second network node corresponds to UL data message monitoring, partial random access message monitoring, full random access message monitoring, or a combination thereof.

In a ninth aspect, alone or in combination with one or more of the first through eighth aspects, the first UL message requests on-demand SIB transmissions for at least the second network node.

In a tenth aspect, alone or in combination with one or more of the first through ninth aspects, the first UL message indicates a detection of a synchronization signal block from the second network node.

In an eleventh aspect, alone or in combination with one or more of the first through tenth aspects, the first UL message requests OD-UL monitoring for a plurality of NES network nodes, and the second UL message is transmitted to the second network node in accordance with the second network node having a highest signal quality of the plurality of NES network nodes.

In a twelfth aspect, alone or in combination with one or more of the first through eleventh aspects, the configuration indicates one or more triggering conditions for requesting OD-UL monitoring, and the one or more triggering conditions include satisfaction of an absolute signal quality threshold, satisfaction of a relative signal quality threshold in accordance with a signal quality of the first network node, reception of paging associated with downlink data, arrival of UL data, satisfaction of an arrival data size threshold, arrival of a type of UL data, or a combination thereof.

In a thirteenth aspect, alone or in combination with one or more of the first through twelfth aspects, the configuration indicates a current UL monitoring status for the one or more network nodes, a starting occasion for transmission of the second UL message, or a combination thereof.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node (e.g., network node 110) or an apparatus of a network node. Example process 700 is an example where the apparatus or the network node performs operations associated with initial access with OD-UL monitoring.

As shown in FIG. 7 in some aspects, process 700 may include transmitting, to a UE, a configuration for OD-UL monitoring associated with one or more network nodes (block 710). For example, the network node (e.g., using transmission component 904 or communication manager 906, depicted in FIG. 9) may transmit, to a UE, a configuration for OD-UL monitoring associated with one or more network nodes, as described above.

As further shown in FIG. 7, in some aspects, process 700 may include receiving, from the UE, a UL message requesting OD-UL monitoring at a second network node of the one or more network nodes in accordance with the configuration (block 720). For example, the network node (e.g., using reception component 902 or communication manager 906, depicted in FIG. 9) may receive, from the UE, a UL message requesting OD-UL monitoring at a second network node of the one or more network nodes in accordance with the configuration, as described above.

As further shown in FIG. 7, in some aspects, process 700 may include transmitting, to the second network node, a message to initiate OD-UL monitoring in accordance with the UL message (block 730). For example, the network node (e.g., using transmission component 904 or communication manager 906, depicted in FIG. 9) may transmit, to the second network node, a message to initiate OD-UL monitoring in accordance with the UL message, as described above.

Process 700 may include additional aspects, such as any single aspect or any combination of aspects described below or in connection with one or more other processes described elsewhere herein.

In a first aspect, the configuration indicates one or more PRACH resources for requesting OD-UL monitoring at the one or more network nodes.

In a second aspect, alone or in combination with the first aspect, the UL message is received via a first PRACH resource of the one or more PRACH resources dedicated for requesting OD-UL monitoring at the second network node.

In a third aspect, alone or in combination with one or more of the first and second aspects, process 700 includes transmitting, to the UE, one or more reference signals indicating that UL monitoring is disabled for the second network node, wherein transmitting the UL message is in accordance with the UL monitoring being disabled.

In a fourth aspect, alone or in combination with one or more of the first through third aspects, the UL message indicates one or more beams for communications with the second network node, an identifier associated with the second network node, or a combination thereof.

In a fifth aspect, alone or in combination with one or more of the first through fourth aspects, the configuration indicates a timing advance difference between the second network node and the network node.

In a sixth aspect, alone or in combination with one or more of the first through fifth aspects, process 700 includes transmitting, to the UE, a response message based at least in part on the UL message, wherein the response message indicates a timing advance associated with the second network node.

In a seventh aspect, alone or in combination with one or more of the first through sixth aspects, the configuration indicates whether OD-UL monitoring for the second network node corresponds to UL data message monitoring, partial random access message monitoring, full random access message monitoring, or a combination thereof.

In an eighth aspect, alone or in combination with one or more of the first through seventh aspects, the UL message requests on-demand SIB transmissions for at least the second network node.

In a ninth aspect, alone or in combination with one or more of the first through eighth aspects, the UL message indicates a detection of a synchronization signal block from the second network node.

In a tenth aspect, alone or in combination with one or more of the first through ninth aspects, the UL message requests OD-UL monitoring for a plurality of NES network nodes.

In an eleventh aspect, alone or in combination with one or more of the first through tenth aspects, the configuration indicates one or more triggering conditions for requesting OD-UL monitoring, and the one or more triggering conditions include satisfaction of an absolute signal quality threshold, satisfaction of a relative signal quality threshold in accordance with a signal quality of the network node, reception of paging associated with downlink data, arrival of UL data, satisfaction of an arrival data size threshold, arrival of a type of UL data, or a combination thereof.

In a twelfth aspect, alone or in combination with one or more of the first through eleventh aspects, the configuration indicates a current UL monitoring status for the one or more network nodes, a starting occasion for transmission of UL messages to the one or more network nodes, or a combination thereof.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE (e.g., UE 120), or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 2-5. Additionally, or alternatively, the apparatus 800 may be configured to perform one or more processes described herein, such as process 600 of FIG. 6. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive, from a first network node, a configuration for OD-UL monitoring associated with one or more network nodes. The transmission component 804 may transmit, to the first network node, a first UL message requesting OD-UL monitoring at a second network node of the one or more network nodes in accordance with the configuration. The transmission component 804 may transmit, to the second network node, a second UL message in accordance with the configuration.

The reception component 802 may receive, from the first network node, one or more reference signals indicating that UL monitoring is disabled for the second network node, wherein transmitting the first UL message is in accordance with the UL monitoring being disabled.

The reception component 802 may receive, from the first network node, one or more reference signals indicating that UL monitoring is enabled for the second network node based at least in part on transmitting the first UL message to the first network node, wherein transmitting the second UL message is in accordance with the UL monitoring being enabled.

The reception component 802 may receive, from the first network node, a response message based at least in part on the first UL message, wherein the response message indicates a timing advance associated with the second network node.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 2-4. Additionally, or alternatively, the apparatus 900 may be configured to perform one or more processes described herein, such as process 700 of FIG. 7. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit, to a UE, a configuration for OD-UL monitoring associated with one or more network nodes. The reception component 902 may receive, from the UE, a UL message requesting OD-UL monitoring at a second network node of the one or more network nodes in accordance with the configuration. The transmission component 904 may transmit, to the second network node, a message to initiate OD-UL monitoring in accordance with the UL message.

The transmission component 904 may transmit, to the UE, one or more reference signals indicating that UL monitoring is disabled for the second network node, wherein transmitting the UL message is in accordance with the UL monitoring being disabled.

The transmission component 904 may transmit, to the UE, a response message based at least in part on the UL message, wherein the response message indicates a timing advance associated with the second network node.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: receiving, from a first network node, a configuration for OD-UL monitoring associated with one or more network nodes; transmitting, to the first network node, a first UL message requesting OD-UL monitoring at a second network node of the one or more network nodes in accordance with the configuration; and transmitting, to the second network node, a second UL message in accordance with the configuration.

Aspect 2: The method of Aspect 1, wherein the configuration indicates one or more PRACH resources for requesting OD-UL monitoring at the one or more network nodes.

Aspect 3: The method of Aspect 2, wherein the first UL message is transmitted to the first network node via a first PRACH resource of the one or more PRACH resources dedicated for requesting OD-UL monitoring at the second network node.

Aspect 4: The method of any of Aspects 1-3, further comprising: receiving, from the first network node, one or more reference signals indicating that UL monitoring is disabled for the second network node, wherein transmitting the first UL message is in accordance with the UL monitoring being disabled.

Aspect 5: The method of any of Aspects 1-4, further comprising: receiving, from the first network node, one or more reference signals indicating that UL monitoring is enabled for the second network node based at least in part on transmitting the first UL message to the first network node, wherein transmitting the second UL message is in accordance with the UL monitoring being enabled.

Aspect 6: The method of any of Aspects 1-5, wherein the first UL message indicates one or more beams for communications with the second network node, an identifier associated with the second network node, or a combination thereof.

Aspect 7: The method of any of Aspects 1-6, wherein the configuration indicates a timing advance difference between the second network node and the first network node.

Aspect 8: The method of any of Aspects 1-7, further comprising: receiving, from the first network node, a response message based at least in part on the first UL message, wherein the response message indicates a timing advance associated with the second network node.

Aspect 9: The method of any of Aspects 1-8, wherein the configuration indicates whether OD-UL monitoring for the second network node corresponds to UL data message monitoring, partial random access message monitoring, full random access message monitoring, or a combination thereof.

Aspect 10: The method of any of Aspects 1-9, wherein the first UL message requests on-demand SIB transmissions for at least the second network node.

Aspect 11: The method of any of Aspects 1-10, wherein the first UL message indicates a detection of a synchronization signal block from the second network node.

Aspect 12: The method of any of Aspects 1-11, wherein the first UL message requests OD-UL monitoring for a plurality of NES network nodes, and wherein the second UL message is transmitted to the second network node in accordance with the second network node having a highest signal quality of the plurality of NES network nodes.

Aspect 13: The method of any of Aspects 1-12, wherein the configuration indicates one or more triggering conditions for requesting OD-UL monitoring, and wherein the one or more triggering conditions include satisfaction of an absolute signal quality threshold, satisfaction of a relative signal quality threshold in accordance with a signal quality of the first network node, reception of paging associated with downlink data, arrival of UL data, satisfaction of an arrival data size threshold, arrival of a type of UL data, or a combination thereof.

Aspect 14: The method of any of Aspects 1-13, wherein the configuration indicates a current UL monitoring status for the one or more network nodes, a starting occasion for transmission of the second UL message, or a combination thereof.

Aspect 15: A method of wireless communication performed by a network node, comprising: transmitting, to a UE, a configuration for OD-UL monitoring associated with one or more network nodes; receiving, from the UE, a UL message requesting OD-UL monitoring at a second network node of the one or more network nodes in accordance with the configuration; and transmitting, to the second network node, a message to initiate OD-UL monitoring in accordance with the UL message.

Aspect 16: The method of Aspect 15, wherein the configuration indicates one or more PRACH resources for requesting OD-UL monitoring at the one or more network nodes.

Aspect 17: The method of Aspect 16, wherein the UL message is received via a first PRACH resource of the one or more PRACH resources dedicated for requesting OD-UL monitoring at the second network node.

Aspect 18: The method of any of Aspects 15-17, further comprising: transmitting, to the UE, one or more reference signals indicating that UL monitoring is disabled for the second network node, wherein transmitting the UL message is in accordance with the UL monitoring being disabled.

Aspect 19: The method of any of Aspects 15-18, wherein the UL message indicates one or more beams for communications with the second network node, an identifier associated with the second network node, or a combination thereof.

Aspect 20: The method of any of Aspects 15-19, wherein the configuration indicates a timing advance difference between the second network node and the network node.

Aspect 21: The method of any of Aspects 15-20, further comprising: transmitting, to the UE, a response message based at least in part on the UL message, wherein the response message indicates a timing advance associated with the second network node.

Aspect 22: The method of any of Aspects 15-21, wherein the configuration indicates whether OD-UL monitoring for the second network node corresponds to UL data message monitoring, partial random access message monitoring, full random access message monitoring, or a combination thereof.

Aspect 23: The method of any of Aspects 15-22, wherein the UL message requests on-demand SIB transmissions for at least the second network node.

Aspect 24: The method of any of Aspects 15-23, wherein the UL message indicates a detection of a synchronization signal block from the second network node.

Aspect 25: The method of any of Aspects 15-24, wherein the UL message requests OD-UL monitoring for a plurality of NES network nodes.

Aspect 26: The method of any of Aspects 15-25, wherein the configuration indicates one or more triggering conditions for requesting OD-UL monitoring, and wherein the one or more triggering conditions include satisfaction of an absolute signal quality threshold, satisfaction of a relative signal quality threshold in accordance with a signal quality of the network node, reception of paging associated with downlink data, arrival of UL data, satisfaction of an arrival data size threshold, arrival of a type of UL data, or a combination thereof.

Aspect 27: The method of any of Aspects 15-26, wherein the configuration indicates a current UL monitoring status for the one or more network nodes, a starting occasion for transmission of UL messages to the one or more network nodes, or a combination thereof.

Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-27.

Aspect 29: An apparatus for wireless communication at a device, the apparatus comprising one or more memories and one or more processors coupled to the one or more memories, the one or more processors configured to cause the device to perform the method of one or more of Aspects 1-27.

Aspect 30: An apparatus for wireless communication, the apparatus comprising at least one means for performing the method of one or more of Aspects 1-27.

Aspect 31: A non-transitory computer-readable medium storing code for wireless communication, the code comprising instructions executable by one or more processors to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

Aspect 33: A device for wireless communication, the device comprising a processing system that includes one or more processors and one or more memories coupled with the one or more processors, the processing system configured to cause the device to perform the method of one or more of Aspects 1-27.

Aspect 34: An apparatus for wireless communication at a device, the apparatus comprising one or more memories and one or more processors coupled to the one or more memories, the one or more processors individually or collectively configured to cause the device to perform the method of one or more of Aspects 1-27.

Aspect 35: A device comprising a processing system that includes one or more processors and one or more code-storing memories coupled with the one or more processors, the processing system configured to cause the device to perform the method of one or more of Aspects 1-27.

Aspect 36: A device comprising a processing system that includes processor circuitry and code-storing memory circuitry, the processing system configured to cause the device to perform the method of one or more of Aspects 1-27.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, from a first network node, a configuration for on-demand uplink monitoring associated with one or more network nodes;
transmit, to the first network node, a first uplink message requesting on-demand uplink monitoring at a second network node of the one or more network nodes in accordance with the configuration; and
transmit, to the second network node, a second uplink message in accordance with the configuration.

2. The UE of claim 1, wherein the configuration indicates one or more physical random access channel (PRACH) resources for requesting on-demand uplink monitoring at the one or more network nodes.

3. The UE of claim 2, wherein the first uplink message is transmitted to the first network node via a first PRACH resource of the one or more PRACH resources dedicated for requesting on-demand uplink monitoring at the second network node.

4. The UE of claim 1, wherein the one or more processors are further configured to cause the UE to:
receive, from the first network node, one or more reference signals indicating that uplink monitoring is disabled for the second network node, wherein transmitting the first uplink message is in accordance with the uplink monitoring being disabled.

5. The UE of claim 1, wherein the one or more processors are further configured to cause the UE to:
receive, from the first network node, one or more reference signals indicating that uplink monitoring is enabled for the second network node based at least in part on transmitting the first uplink message to the first network node, wherein transmitting the second uplink message is in accordance with the uplink monitoring being enabled.

6. The UE of claim 1, wherein the first uplink message indicates one or more beams for communications with the second network node, an identifier associated with the second network node, or a combination thereof.

7. The UE of claim 1, wherein the configuration indicates a timing advance difference between the second network node and the first network node.

8. The UE of claim 1, wherein the one or more processors are further configured to cause the UE to:
receive, from the first network node, a response message based at least in part on the first uplink message, wherein the response message indicates a timing advance associated with the second network node.

9. The UE of claim 1, wherein the configuration indicates whether on-demand uplink monitoring for the second network node corresponds to uplink data message monitoring, partial random access message monitoring, full random access message monitoring, or a combination thereof.

10. The UE of claim 1, wherein the first uplink message requests on-demand system information block (SIB) transmissions for at least the second network node.

11. The UE of claim 1, wherein the first uplink message indicates a detection of a synchronization signal block from the second network node.

12. The UE of claim 1, wherein the first uplink message requests on-demand uplink monitoring for a plurality of NES network nodes, and wherein the second uplink message is transmitted to the second network node in accordance with the second network node having a highest signal quality of the plurality of NES network nodes.

13. The UE of claim 1, wherein the configuration indicates one or more triggering conditions for requesting on-demand uplink monitoring, and wherein the one or more triggering conditions include satisfaction of an absolute signal quality threshold, satisfaction of a relative signal quality threshold in accordance with a signal quality of the first network node, reception of paging associated with downlink data, arrival of uplink data, satisfaction of an arrival data size threshold, arrival of a type of uplink data, or a combination thereof.

14. The UE of claim 1, wherein the configuration indicates a current uplink monitoring status for the one or more network nodes, a starting occasion for transmission of the second uplink message, or a combination thereof.

15. A method of wireless communication performed by a user equipment (UE), comprising:
receiving, from a first network node, a configuration for on-demand uplink monitoring associated with one or more network nodes;
transmitting, to the first network node, a first uplink message requesting on-demand uplink monitoring at a second network node of the one or more network nodes in accordance with the configuration; and
transmitting, to the second network node, a second uplink message in accordance with the configuration.

16. The method of claim 15, wherein the configuration indicates one or more physical random access channel (PRACH) resources for requesting on-demand uplink monitoring at the one or more network nodes.

17. The method of claim 16, wherein the first uplink message is transmitted to the first network node via a first PRACH resource of the one or more PRACH resources dedicated for requesting on-demand uplink monitoring at the second network node.

18. The method of claim 15, further comprising:
receiving, from the first network node, one or more reference signals indicating that uplink monitoring is disabled for the second network node, wherein transmitting the first uplink message is in accordance with the uplink monitoring being disabled.

19. The method of claim 15, further comprising:
receiving, from the first network node, one or more reference signals indicating that uplink monitoring is enabled for the second network node based at least in part on transmitting the first uplink message to the first network node, wherein transmitting the second uplink message is in accordance with the uplink monitoring being enabled.

20. A non-transitory computer-readable medium storing a set of instructions for wireless communication, the set of instructions comprising:
one or more instructions that, when executed by one or more processors of a user equipment (UE), cause the UE to:
receive, from a first network node, a configuration for on-demand uplink monitoring associated with one or more network nodes;
transmit, to the first network node, a first uplink message requesting on-demand uplink monitoring at a second network node of the one or more network nodes in accordance with the configuration; and
transmit, to the second network node, a second uplink message in accordance with the configuration.
